(19) United States
(12) Patent Application Publication
(10) Pub. No.: US 2015/0166407 A1
(43) Pub. Date: Jun. 18, 2015

(54) STRENGTHENED GLASS AND METHODS FOR MAKING UTILIZING ELECTRIC FIELD ASSIST

(71) Applicant: Saxon Glass Technologies, Inc., Alfred, NY (US)

(72) Inventors: Arun K. Varshneya, Alfred, NY (US); Garrett A. Olson, Alfred Station, NY (US); Patrick K. Kreski, Alfred Station, NY (US)

(73) Assignee: Saxon Glass Technologies, Inc., Alfred, NY (US)

(21) Appl. No.: 14/562,745

(22) Filed: Dec. 7, 2014

Related U.S. Application Data
(60) Provisional application No. 61/913,323, filed on Dec. 8, 2013.

(51) Int. Cl. C03C 21/00

(52) U.S. Cl. CPC C03C 21/003; C03C 21/007; C03C 21/008

(57) ABSTRACT

Chemically strengthened glass with high surface compression, deeper case depth, shorter processing time and a reduced induced curvature relative to that obtained in a traditional immersion method and a method for making utilizing an electric filed assist are provided. The method includes providing a substrate, characterized by having a glass chemical structure including host alkali ions having an average ionic radius situated in the glass chemical structure. The method also includes exposing the substrate to the exchange medium; and conducting ion exchange to produce a strengthened substrate while exposing the substrate to the exchange medium and applying an electric field in a plurality of cycles across the surfaces of the substrate.

### PRIORITY

This application claims priority to U.S. Provisional Application No. 61/913,323 entitled “Strengthened Glass and Methods for Making Using an Electric Field” by Arun K. Varshneya et al. filed on Dec. 8, 2013, which is incorporated herein by reference in its entirety.

### BACKGROUND

Chemical strengthening of glass, also called ion-exchange strengthening or chemical tempering, is a technique to strengthen a prepared glass article by increasing compression within the glass itself. It generally involves introducing larger alkali ions into the glass chemical structure to replace smaller alkali ions already present in the structure. A common implementation of chemical strengthening in glass occurs through the exchange of sodium ions, having a relatively smaller ionic radius, with potassium ions, having a relatively larger ionic radius by submerging a glass substrate containing the sodium ions in a bath containing molten potassium salts (i.e., the immersion technique).

Chemical strengthening is often utilized to increase compression in glass. Increased compression within the glass surface of a glass part is associated with increased strength, increased abrasion resistance and/or increased thermal shock resistance in the glass. The increased compression can be introduced to various depths in glass. Chemical strengthening is commonly utilized for treating flat glass. But it may also be used for treating non-flat glass articles, such as cylinders and other shapes of greater geometric complexity.

Those familiar with the art of glass chemical strengthening also recognize that the traditional immersion methods commonly are associated with excessively long immersion times, usually 4 to 24 hours, such as for strengthening soda-lime silicate and sodium borosilicate glasses in order to produce a case depth of about 5 to 30 microns or more to provide effective protection against common handling flaws. For instance, commercial soda-lime silicate glass is often strengthened at temperatures such as 450° C. for about 8 hours to obtain about 400 to 500 MPa surface compression and case depths of about 15 to 20 microns.

A high surface compression magnitude and a deep case depth are often desirable. In glass, the ion exchange by immersion is a slow process. The long immersion time is necessary because the penetration of invading potassium ions into the glass increases with square-root of time. The long immersion time also incurs concurrent stress relaxation; hence, it is difficult to generate surface compressions much above 600 MPa in commercial soda-lime silicate glass and above 800 MPa in commercial sodium aluminosilicate. Stress relaxation often increases at higher immersion temperatures as well as for longer immersion times.

Flat glass is commonly manufactured by a number of known techniques. These include the float glass method and drawing methods, such as the fusion down-draw method and the slot-draw method. However, a prepared flat glass article may have variations in its chemical composition and/or structure at different locations in the glass. For example, flat glass that is manufactured by the float glass technique is often prepared by spreading softened glass material on a molten metal surface such as tin. The glass is then cooled to form a solid, flat glass. As a result, the prepared flat glass often contains a greater amount of tin on the side that was nearer the molten tin and the concentration of tin is commonly greater near the surface of that side—often termed the “tin side” or “tin surface”. The side of the sheet exposed to the gaseous atmosphere during the float process is often termed the “air side” or “air surface”.

Chemical strengthening is often used to treat glass having variations in chemical composition and/or structure at different locations in the glass. The variations produce locations that are treatment-rich (i.e., allowing more interdiffusion with invading alkali ions) or treatment-poor (i.e., allowing less interdiffusion with invading alkali ions) relative to each other for ion exchange and/or compression development in chemical strengthening. When chemical strengthening is used to treat such glass, the introduced compressive stress is often not uniformly distributed.

After chemical strengthening different sides of a glass substrate, compressive stress is often not evenly distributed on different sides in the strengthened glass. The different sides have imbalanced compressive stress profiles within the depths of the chemical strengthening layers on the different sides in the strengthened glass. The imbalanced compressive stress profiles can produce deleterious effects in articles incorporating such strengthened glass. For example, an imbalanced compressive stress distribution in a chemically strengthened flat glass may introduce a bending moment causing an induced curvature in a glass when treated by chemical strengthening. The effect of introducing induced curvature by chemical strengthening is particularly apparent for glass articles having a smaller width. This is commonly problematic in flat glass having a smaller width, such as less than 25 millimeters, as the bending moment in thinner glass introduces greater curvature from chemical strengthening. Float glass substrates having a width of 2.0 mm or less, and particularly those having a width of 1.0 mm or less, often suffer from having highly significant curvature introduced through chemical strengthening.

Induced curvature is often undesirable and is often especially problematic in manufacturing thin flat glass articles according to manufacturing specifications that call for the enhanced physical properties associated with chemical strengthening, but without significant induced curvature. For example, glass used in many manufactured electronic articles, such as displays for “smart” phones, often requires a display glass that is substantially flat and high in strength and in abrasion resistance.

For glass articles having a thin cross-section, bending stresses from chemical strengthening often generate deflection in the glass article and thus introducing curvature. This is especially common in glass made by a float glass method. Deflection is also commonly generated in glasses made by other methods that have variations in chemical structure or composition within the glass. A thin glass article manufactured using a float glass process often exhibits measurable curvature after chemical strengthening. The direction of curvature is often concave on a treatment-poor surface (i.e., allowing less interdiffusion with invading alkali ions) and convex on a treatment-rich surface (i.e., allowing more interdiffusion with invading alkali ions). For a float glass method produced sheet, the treatment-poor surface is often the tin surface and the treatment-rich surface is often the air surface.

In recent years, various types of efforts have been made attempting to overcome the problem of induced curvature in chemical strengthening of glass. One approach involves grinding and polishing a glass substrate prior to chemical strengthening. The grinding and polishing is performed to remove those parts of a glass having a different chemical composition and/or structure. An example of this approach is grinding and polishing a flat glass made by the float method to remove the surface layer(s) containing a significant amount of tin. However, grinding and polishing a float glass article often introduces surface abrasions and may introduce other physical defects in the glass. These defects are compounded by the added time and expense associated with performing the grinding and polishing.

Chemical strengthening of a thin, flat glass substrate, such as an article having two major surfaces and variations in chemical structure or composition within the glass, is often associated with a non-equivalence of interdiffusion of invading alkali ions and/or compression generation properties between the major surfaces of the substrate. The effect is that local forces in the glass about the mid-plane are not equivalent as these occur from the mid-plane of a glass article to its surfaces, i.e. the product of local force and distance from the mid-plane is not equivalent when summed from the treatment-poor surface to the mid-plane and from the treatment-rich surface to the mid-plane. Thus the net bending moment about the mid-plane in the glass is non-zero (i.e., there is a non-zero net bending moment of the stress about the mid-plane). As a result, bending stresses are generated.

Other approaches have involved secondary chemical treatments of prepared glass done prior to chemical strengthening. The secondary chemical treatments are utilized in an attempt to address differences in chemical composition and/or structure at different locations in the glass. However secondary chemical treatments can alter the physical properties of the glass and otherwise degrade a strengthened glass article produced through subsequent chemical strengthening. Also secondary chemical treatments also involve the time and expense of extra processing done prior to chemical strengthening.

Attempts to control and balance compressive stress profiles associated with different sides in a chemically strengthened glass using known methods, such as the longer immersion times for traditional chemical strengthening, have not been successful. This is because such treated glasses suffer from reduced surface compression at the surface of the glass due to the increased exposure while the glass is being treated during ion exchange to balance the compressive stress profiles on the different sides. As noted above, the increased exposure during chemical strengthening introduces a relaxation at the glass surface, thus reducing surface compression in the treated glass. A reduced surface compression is undesirable as it has a negative impact on the glass strength, abrasion resistance, and/or thermal shock resistance of the treated glass. Furthermore, the chemical strengthening process should be rapid to be cost-efficient.

Given the foregoing, chemically strengthened glass and methods for making chemically strengthened glass are desired in which the strengthened glass has a balanced compressive stress profile and a high surface compression on the different sides of the treated glass and has shorter chemical strengthening process time. It is also desired that the strengthened glass having reduced induced curvature also have the improved physical properties of chemically strengthened glass, such as higher strength, higher abrasion resistance, and/or higher thermal shock resistance.

### SUMMARY

This summary is provided to introduce a selection of concepts. These concepts are further described below in the detailed description in conjunction with the accompanying drawings. This summary is not intended to identify key or essential features of the claimed subject matter, nor is this summary intended as an aid in determining the scope of the claimed subject matter.

According to an implementation, there is a method for making including providing a substrate having a first surface and a second surface. The substrate may be characterized by having a glass chemical structure including host alkali ions situated in the structure and having an average ionic radius. The method may also include providing an exchange medium including invading alkali ions having an average ionic radius that is larger than an average ionic radius of the host alkali ions. The method may also include exposing the substrate to the exchange medium. The method may also include conducting ion exchange to produce a strengthened substrate while exposing the substrate to the exchange medium and applying an electric field across the surfaces of the substrate. Applying the electric field may include reversing a polarity of the electric field through a plurality of cycles. The strengthened substrate may have a first compressive stress layer extending from the first surface into the substrate and may have a second compressive stress layer extending from the second surface into the substrate. The strengthened substrate may have a balanced compressive stress profile based on a first plot of first compressive stress amounts at first depths from the first surface within the first compressive stress layer, a second plot of second compressive stress amounts at second depths from the second surface within the second compressive stress layer, and at a corresponding first depth and second depth from the respective surfaces, may have a magnitude of a difference between a first compressive stress amount at the first depth and a second compressive stress amount at the second depth, that may be less than 500 MPa.

According to another implementation, there is an article of manufacture that includes a strengthened substrate having a first surface and a second surface. The strengthened substrate may be characterized by having a glass chemical structure including host alkali ions and invading alkali ions situated in the structure and an average ionic radius of the invading alkali ions is greater than an average ionic radius of the host alkali ions. The strengthened substrate may have a first compressive stress layer extending from the first surface into the substrate and a second compressive stress layer extending from the second surface into the substrate. The strengthened substrate may have a balanced compressive stress profile based on a first plot of first compressive stress amounts at first depths from the first surface within the first compressive stress layer, a second plot of second compressive stress amounts at second depths from the second surface within the second compressive stress layer, and at a corresponding first depth and second depth from the respective surfaces, may have a magnitude of a difference between a first compressive stress amount at the first depth and a second compressive stress amount at the second depth, that may be less than 500 MPa. The strengthened substrate may have a surface compression wherein, if the glass is sodium borosilicate having ≧4 mol % and <8 mol % Na₂O below the case depth, the surface compression is one of >360 MPa having a case depth≧20 μm, >390 MPa having a case depth<20 μm and ≧15 μm, >420 MPa having a case depth<15 μm and ≧10 μm, and >470 MPa having a case depth less than 10 μm. The strengthened substrate may have a surface compression wherein, if the glass is sodium borosilicate having ≧8 mol % and <12 mol % Na₂O below the case depth, the surface compression is one of >600 MPa having a case depth>20 μm, >650 MPa having a case depth<20 μm and ≧15 μm, >700 MPa having a case depth<15 μm and >10 μm, and >780 MPa having a case depth less than 10 μm. The strengthened substrate may have a surface compression wherein, if the glass is soda-lime silicate, the surface compression is one of >700 MPa having a case depth≧20 μm, >750 MPa having a case depth<20 μm and ≧15 μm, >800 MPa having a case depth<15 μm and ≧10 μm, and >900 MPa having a case depth<10 μm. The strengthened substrate may have a surface compression wherein, if the glass is alkali aluminosilicate, the surface compression is one of >900 MPa having a case depth≧30 μm, >950 MPa having a case depth<30 μm and ≧20 μm, >1000 MPa having a case depth<20 μm.

According to another implementation, there is an article of manufacture that includes a strengthened substrate having a first surface and a second surface. The strengthened substrate may be characterized by having a glass chemical structure including host alkali ions and invading alkali ions situated in the structure and an average ionic radius of the invading alkali ions is greater than an average ionic radius of the host alkali ions. The strengthened substrate may have a first compressive stress layer extending from the first surface into the substrate and a second compressive stress layer extending from the second surface into the substrate. The strengthened substrate may have a balanced compressive stress profile based on a first plot of first compressive stress amounts at first depths from the first surface within the first compressive stress layer, a second plot of second compressive stress amounts at second depths from the second surface within the second compressive stress layer, and at a corresponding first depth and second depth from the respective surfaces, may have a magnitude of a difference between a first compressive stress amount at the first depth and a second compressive stress amount at the second depth, that may be less than 500 MPa. The strengthened substrate may be made by a process comprising conducting ion exchange to produce the strengthened substrate while exposing a substrate to an exchange medium and applying an electric field across the surfaces of the substrate.

The above summary is not intended to describe each embodiment or every implementation. Further features, their nature and various advantages are described in the accompanying drawings and the following detailed description of the examples and embodiments.

### BRIEF DESCRIPTION OF THE DRAWINGS

The accompanying drawings, which are incorporated in and constitute a part of this specification, illustrate one or more embodiments described herein and, together with the description, explain these embodiments. In addition, it should be understood that the drawings are presented for example purposes only. In the drawings:

FIG. 1 shows a flowchart illustrating an exemplary overview of a process for making a strengthened substrate.

FIG. 2 shows a flowchart illustrating an exemplary overview of a process for making a flat strengthened substrate.

FIG. 3 shows a graph illustrating a current versus time profile during electric field-assist chemical strengthening process.

FIG. 4 shows a graph illustrating a current versus time profile during electric field-assist chemical strengthening process.

FIG. 5 shows a graph illustrating a current versus time profile during electric field-assist chemical strengthening process.

FIG. 6 shows a graph illustrating three current versus time profiles during electric field-assist chemical strengthening process.

FIG. 7 shows a graph illustrating surface compression with respect to number of cycles on chemically strengthened samples using the electric field-assist chemical strengthening process.

FIG. 8 shows a graph illustrating case depth with respect to number of cycles on chemically strengthened samples using the electric field-assist chemical strengthening process.

FIG. 9 shows a graph illustrating compressive stress profiles with respect to number of cycles on chemically strengthened samples using the electric field-assist chemical strengthening process.

FIG. 10 shows a graph illustrating comparative differences of compressive stress profiles on different sides of a strengthened glass with respect to number of cycles on chemically strengthened samples using the electric field-assist chemical strengthening process.

### DETAILED DESCRIPTION

The following detailed description refers to the accompanying drawings. The same reference numbers in different drawings identify the same or similar elements.

### Overview

The present invention is directed to chemically strengthened glass and methods of making chemically strengthened glass utilizing an electric field. The present invention is particularly advantageous for making chemically strengthened glass having a balanced compressive stress profile and a high surface compression with less time associated with the chemical strengthening process. By utilizing an electric field of select parameters, significantly less process time is needed to obtain strengthened glasses compared to traditional immersion chemical strengthening processes. The electric field methodology described herein allows rapid development of deep case depth—the time can be a factor of 4 to 10 lower relative to traditional immersion chemical strengthening processes. Because of the rapid nature of the electric field methodology, concurrent stress relaxation is much lesser. Hence, the electric field-assist methodology produces much higher surface compression. Alternatively, much deeper case depths are obtainable for comparable surface compression obtained using traditional immersion chemical strengthening techniques. Further balanced stress profiles from the two surfaces are realized. Further, the present method allows induced deflection in the strengthened glass to be controlled by the electric field-assist methodology as stress imbalance is reduced. This reduces curvature in thin flat coupons.

As noted above, utilizing an electric field, according to the present invention, allows for production of strengthened glass having a higher magnitude of surface compression. For example, in soda-lime silicate float-produced thin glass sheets made utilizing an electric field-assist, the magnitude of surface compression is often greater than that obtained for conventionally chemically strengthened alkali aluminosilicate glasses such as Corning's GORILLA® glass and AGC's DRAGONTAIL® glass. These alkali aluminosilicate glasses are considerably more expensive to produce than float-produced soda-lime silicate glasses. Furthermore, since the processing time is short, the generated stresses in the glass do not relax significantly. As a result, significantly higher magnitudes of surface compression may be obtained in a final product. This provides more robust protection against abrasion and impact for glass articles, such as display screen glass used in personal mobile electronic devices. Similarly, large display devices can be manufactured using thinner, lighter weight, yet stronger glass sheets.

A chemically strengthened glass, made according to the principles of the invention, does not have the drawbacks associated with chemically strengthened glasses made utilizing grinding and polishing or secondary chemical treatment(s) when done prior to chemical strengthening. While the present invention is not necessarily limited to such applications, various aspects of the invention are appreciated through a discussion of various examples using this context.

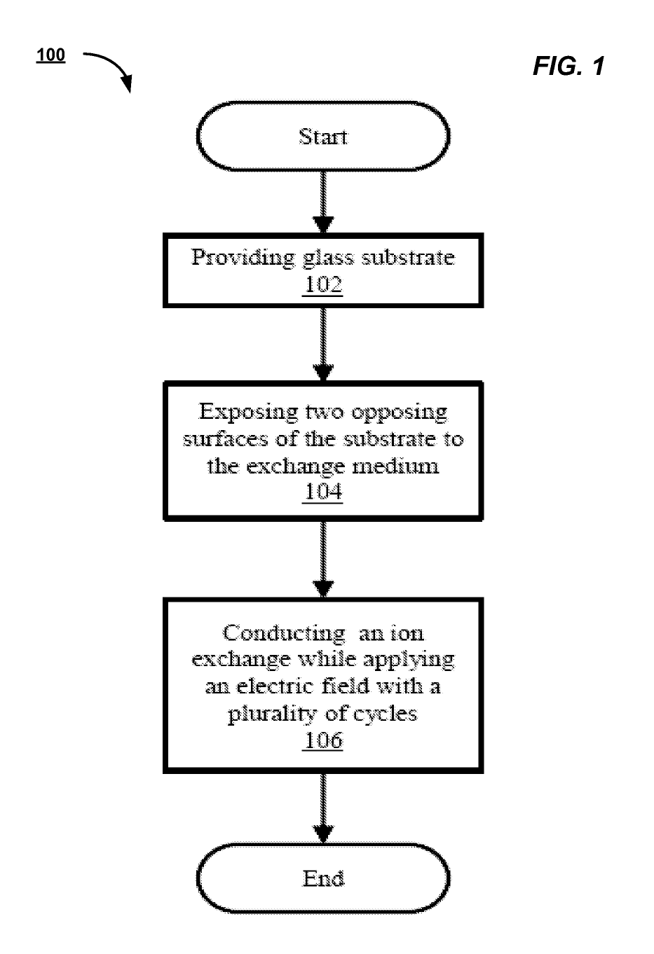

FIG. 1 is a flow chart illustrating an exemplary overview of an implementation described herein. At step 102, a glass substrate is provided. The glass substrate may have a first surface and a second surface.

At step 104, separate exchange mediums are applied to the first surface and to the second surface. Electrode materials may be placed atop or within the exchange mediums to improve the distribution of a DC electric field in later steps.

At step 106, an ion exchange is conducted with an applied electric field driving ions from the first surface toward the second surface, thereby introducing invasive ions into the first surface at an increased rate relative to traditional immersion chemical strengthening and establishing a “forward half-cycle”. After a goal or threshold is met, such as an elapsed period of applied electric field time, the polarity of the DC electric field is reversed, driving ions from the second surface toward the first surface, thereby introducing invasive ions into the second surface at an increased rate relative to traditional immersion chemical strengthening and establishing a “backward half-cycle”. The combination of a forward half-cycle and a backward half-cycle establishes one cycle. A plurality of cycles and other electric field-assisted chemical strengthening parameters are selected to obtain balanced compressive stress profiles with a desired case depth while maintaining high surface compression and short processing time.

The electric field-assisted chemical strengthening parameters of number of cycles, cycle period, cycle voltage, and cycle current may be modified from cycle to cycle or from forward half-cycle to backward half-cycle to obtain balanced compressive stress profiles with a desired case depth while maintaining high surface compression.

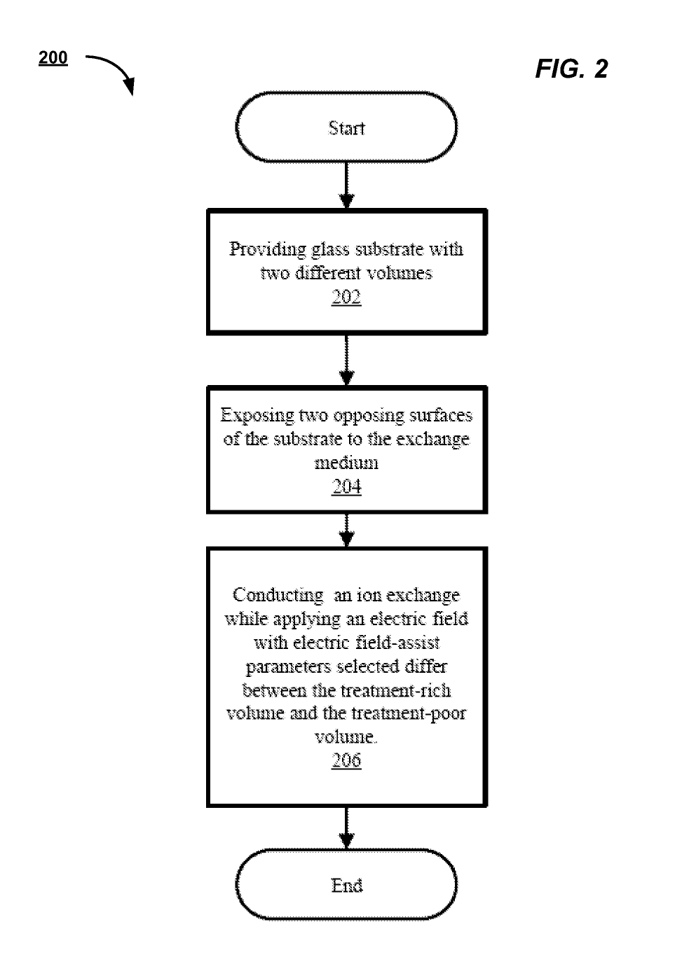

FIG. 2 is a flow chart illustrating an exemplary process for making a flat strengthened substrate. At step 202, a glass substrate is provided. The glass substrate has a first surface with first volume and a second surface with a second volume. The volumes are located as diametrically opposed to each other in the substrate. The glass substrate may have variations in the different volumes, such as a variation in chemical composition and/or chemical structure. One type of variation has a chemical composition and/or chemical structure that is more readily treated by chemical strengthening and is a “treatment-rich” volume. Another type of variation has a chemical composition and/or chemical structure that is less readily treated by chemical strengthening and is a “treatment-poor” volume. The term “treatment-rich volume” refers to a volume of a glass substrate which exhibits faster alkali ion interdiffusion and/or greater compression development during chemical strengthening relative to a “treatment-poor volume” under equivalent chemical strengthening conditions applied to the glass substrate. A volume may occur at a surface of a substrate, or in a space or layer beneath the surface. A treatment-rich volume or treatment-poor volume may be a surface layer of a glass substrate in which the diffusion of invading alkali ions extends to a given “diffusion depth” from the surface, also called a penetration depth or a diffusion layer. In chemical strengthening, a portion of the diffusion depth is in compressive stress, called case depth. Case depth is the width of the diffusion layer that is in compressive stress in a specimen.

An example of a variation in chemical composition is an amount of tin situated in different volumes of the glass. Another example of a variation in chemical structure is the presence of tin in different valences, Sn²⁺ and Sn⁴⁺ in different volumes of the glass. A variation in chemical composition and/or chemical structure in the treatment-poor volume may distinguish it from the treatment-rich volume. Allow the treatment-poor volume to be associated with the first volume and the treatment-rich volume to be associated with the second volume for convenience.

At step 204, separate exchange mediums are applied to the first surface and to the second surface. Electrode materials may be placed atop or within the exchange mediums to improve the distribution of a DC electric field in later steps.

At step 206, an ion exchange is conducted with an applied electric field driving ions from the first surface toward the second surface, thereby introducing invasive ions into the first surface at an increased rate relative to traditional chemical strengthening and establishing a “forward half-cycle”. After a goal or threshold is met, such as an elapsed period of applied electric field time, the polarity of the DC electric field is reversed, driving ions from the second surface toward the first surface, thereby introducing invasive ions into the second surface at an increased rate relative to traditional chemical strengthening and establishing a “backward half-cycle”. The combination of a forward half-cycle and a backward half-cycle establishes one cycle.

The electric field-assisted chemical strengthening parameters of number of cycles, cycle period, cycle voltage, and cycle current may be modified from cycle to cycle or from forward half-cycle to backward half-cycle to obtain balanced compressive stress profiles with a desired case depth while maintaining high surface compression in a short processing time. These electric field-assisted chemical strengthening parameters may also be selected and modified to remedy differences between the ion exchange characteristics of the first surface with a treatment-poor volume and the second surface with a treatment-rich volume. In such cases, the balanced compressive stress profiles produce a net bending moment about mid-plane of the substrate of about zero in a fully strengthened substrate. In turn, induced curvature has been reduced or nullified through applying the different electric field parameters to the different volumes. Further, the process time has been significantly reduced for a desired case depth while maintaining high surface compression.

### Representative Embodiments

Although described specifically throughout the entirety of the disclosure, the representative examples have utility over a wide range of applications, and the above discussion is not intended and should not be construed to be limiting. The terms, descriptions, tables and figures used herein are set forth by way of illustration only and are not meant as limitations. Those skilled in the art recognize that many variations are possible within the spirit and scope of the principles of the invention. While the examples have been described with reference to the tables and figures, those skilled in the art are able to make various modifications to the described examples without departing from the scope of the following claims, and their equivalents.

The operation and effects of certain embodiments can be more fully appreciated from the examples, as described below. The embodiments on which these examples are based are representative only. The selection of these embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims or their equivalents. The significance of the examples may be better understood by comparing the results obtained therefrom with potential results which may be obtained from tests or trials that may be, or may have been, designed to serve as controlled experiments and to provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

The meaning of abbreviations and certain terms used herein is as follows: “V” means volt(s), “mA” means milliamp(s), “min” means minute(s), “mm” means millimeter(s), “μm” means micrometer(s) or micron(s), “g” means gram(s), “mol” means mole(s), “mmol” means millimole(s), “wt %” means percent by weight and “mol %” means percent by mole.

### Exemplary Substrate Glasses

As used herein a “glass substrate” may comprise any kind of ion-exchangeable glass. Examples of such glass include soda-lime silicate glass, alkali aluminosilicate glass or sodium borosilicate glass, though other glass compositions are contemplated including glasses where glass forming components are free of silica, such as boron oxide (borate), phosphorous oxide (phosphate), aluminum oxide (aluminate), etc. As used herein, “ion exchangeable” means that a glass substrate is capable of exchanging alkali ions located in the glass structure of the substrate (i.e., “host alkali ions”), such as at or near the surface of the substrate, with larger alkali ions (i.e., “invading alkali ions”) from an exchange medium that may be a liquid, solid or gas. An “ion exchange rate” refers to an amount of invading ions entering a substrate over a period of time. A glass may have chemical composition and/or chemical structure variations at different locations or “volumes” in the glass. An example of chemical composition variation is an excess of metal, such as metal ions or other forms of metal and may include a metal species, such as tin or lead. An example is metal that remains in a flat glass made by a float glass method, such as tin. An example of chemical structure variation is the presence of an element in the glass in which the element may have different valences throughout different volumes, such as tin present in Sn²⁺ and Sn⁴⁺ valences in the different volumes. In this example, the different forms of tin form different chemical structures in the different volumes.

Exemplary embodiments of substrate glasses include silicate glasses, such as soda-lime silicate glass or sodium aluminosilicate glass that includes alumina or sodium borosilicate glass that includes boron oxide, at least one alkali metal and, in some embodiments, greater than 50 mol % SiO2, in other embodiments at least 58 mol % SiO2, and in still other embodiments at least 60 mol % SiO2.

Exemplary embodiments of a glass thickness which may be utilized in an electric field-assist may be as low as 0.001 mm and as high as 30 mm. In a preferred embodiment, the glass thickness may vary from 0.010, 0.025, 0.1, 1, 2, 3, 4, 4, 10, 25 to 30 mm.

### Exemplary Exchange Mediums

Exemplary embodiments of a liquid exchange medium which may be utilized in chemical strengthening include liquid molten salt baths. The molten liquid baths include invading alkali ions having an average ionic radius in the alkali metal ion of the molten salt that is larger than an average ionic radius of host alkali metal ions in the substrate glass prior to ion exchange. A common example of a liquid molten salt bath includes potassium nitrate with potassium as the invading alkali ion to replace sodium and/or lithium host ions in the substrate glass. Another common example of a liquid molten salt bath includes sodium nitrate with sodium as the invading alkali ion to replace lithium host ions in the substrate glass.

Mixed salt blends of invading alkali ions may also be used as liquid exchange mediums. These blends may include salts of different alkali metals, preferably different alkali metal nitrates. A nitrate melt blend may include at least two different alkali ions, for example Na and K, and/or Na and Rb. It is also possible that three or four different alkali metals are included. Rb ions or Cs ions may be used in chemical strengthening. The method according to the embodiment offers the option to effectively incorporate invading alkali ions into a treated glass article having ionic radii that are significantly larger than the radii of host alkali ions, such as lithium or sodium ions.

Exemplary embodiments of a solid exchange medium which may be utilized in chemical strengthening include semi-solid pastes that may be applied to a surface of a glass substrate. The paste includes invading alkali ions from a source such as a salt and at least one rheological agent, such as clay, to suspend the ions in the solid exchange medium. Kaolin is a common example of a rheological agent which may utilized in making a solid exchange medium. The viscosity of a paste made with kaolin may be modified with water and other additives to suit an application by which the paste is applied to a glass substrate. Water content of a paste may be evaporated prior to application as a solid exchange medium utilizing a raised high temperature, such as greater than 120° C. Another example of a rheological agent is aluminosilicate fiber. Other clays and rheological agents are also contemplated.

In addition to liquid and solid exchange mediums, gas exchange mediums are also contemplated.

### Exemplary Electric Field Assist Parameters

Exemplary embodiments of a number of cycles which may be utilized in an electric field assist may be as low as 2 and as many as 16 cycles. In a preferred embodiment, the number of cycles which may be utilized may be as low as 3 and as many as 10 cycles. In other embodiments, 4 to 9 cycles, 5 to 8 cycles and 6 to 7 cycles. A cycle may include applying DC electrical field to the two surfaces without having a short-circuit path first for a forward half-cycle of the ion flux and then reversing the polarity to drive the ion flux for the backward half-cycle. Electrical parameters and the time used for each half-cycle may be the same or different in a predetermined manner.

An exemplary embodiment of a voltage which may be utilized in an electric field-assist process may be as low as 1 volt/mm and as high as 1000 volts/mm of the substrate width. In a preferred embodiment, the voltage may vary from 10, 50, 100, 200, 300, 400, 500 to 600 volts/mm of the substrate width.

An exemplary embodiment of a current which may be utilized in an electric field-assist process may be as low as 0.0001 amps/square inch (i.e., 0.155 microamps/square mm) and as high as 10 amps/square inch (i.e., 0.0155 amps/square mm) of a surface area of the substrate. In a preferred embodiment, the current may vary from 0.001, 0.01, 0.1, 1, 2, 3, 4 to 5 amps/square inch of a surface area of the substrate.

An exemplary embodiment of a time during which an electric field-assisted chemical strengthening process may be executed is as short as 0.01 hours and as long as 5 hours. In a preferred embodiment, the time may vary from 0.02, 0.05, 0.1, 0.3, 0.5, 1, 2, 3 to 4 hours.

An exemplary embodiment of a temperature in which an electric field-assisted chemical strengthening process may be executed may be as low as 20° C. and as high as 900° C. In a preferred embodiment, the temperature may vary from 50, 100, 150, 200, 300, 400, 500, 600, 700, and 800 to 900° C.

The application of DC potential across the first and second surfaces of a glass plate causes faster alkali ion motion across the exchange medium-to-glass surface interface and within the glass relative to traditional immersion chemical strengthening. A positive polarity plate (the “anode”) of a DC source is connected to the exchange medium on the first surface and the negative polarity plate (the “cathode”) of the DC source is connected to the exchange medium on the second surface of the glass. An ionic flux, primarily composed of positive alkali ions, such as sodium, contained within the glass volume adjacent to the cathode exchange medium flows across the second surface to the cathode where the ions receive electrons from the DC source negative plate to become neutral atoms. In turn other ions, such as potassium ions from an anode exchange medium may enter the adjacent glass volume, in this case, the first surface. The nitrate ions in the anode exchange medium are outgassed as nitrogen oxide and oxygen gas after giving up an electron. The given up electron reaches the anode plate of the DC source and the electric circuit is completed.

Within the glass itself, the charge may then be carried by an equivalent number of alkali ions moving with a velocity that is significantly faster than that determined by their chemical diffusion coefficient. Rapid ion exchange strengthening occurs in the anode region (the first surface) where an adequate supply of invasive potassium ions is maintained in the exchange medium electrode. To perform ion exchange strengthening on the second surface, the polarity is reversed allowing the entry of potassium ions from the second surface. A “cycle” thus includes having a polarity such that ions are driven from first surface to the second surface (measured as “negative current”, since the electrons flow from the second to the first) and then reversing the polarity to drive the ions from the second to the first surface (measured as “positive current”).

If the motion of potassium ions were analogous to a wall of ions moving forward and backward through the glass, then a time allotted for a backward half-cycle may be half of the forward half-cycle to obtain a balanced concentration profile of potassium ions on both sides. Because the mobility of potassium ions in glass is less than that of the sodium ions, the relationship between the forward half-cycle and the backward half-cycle is complex.

In the Examples below, the tin surface of a float-produced glass may correspond to a “first” surface and the air surface may correspond to a “second” surface. When the ions are driven from the first (i.e., tin) surface to the second (i.e., air) surface, it is called a “forward half-cycle” and when the ions are driven from the second surface to the first surface, it is called a “backward half-cycle”. Correspondingly, when the electronic current flows from the second surface to the first surface, it is referred to as a “negative current” and when the electronic current flows from the first surface to the second surface, it is referred to as a “positive current.” Since the stress generated at any location is proportional to the concentration of the invading potassium ions at that location, a balance of stress profiles may be estimated by continuously monitoring the time-integrated negative current and the positive current. In addition, since the deflection of the substrate results from an imbalance of stresses in the two surface regions, a continuous monitoring of the edge deflection remotely may also be used to estimate the balancing of compressive stress profiles. Other methodologies, such as empirical testing on a pre-production sample to establish an estimated compressive stress profile, are known to those having ordinary skill in the art.

In an exemplary embodiment, edge strengthening is utilized. In electric field-assisted chemical strengthening, minor edge surfaces may be left free of contact with an exchange medium to prevent a short-circuit path between the large surfaces. This may leave the edges weak. Edge strengthening may be utilized to pre-strengthen the edges by applying an exchange medium to the edges and performing a thermal chemical strengthening process for a short time. For soda-lime silicate glass, an example edge strengthening parameter may be about 450° C. for about 0.5 hours. This is sufficient to develop approximately 5 microns case depth on the edge surfaces which reduces breakage during electric field-assisted chemical strengthening.

### Example 1

Example 1 demonstrates the preparation of a strengthened soda-lime silicate glass with the electric field-assist chemical strengthening process.

Sample Preparation:

Soda-lime silicate coupons, 25 mm×25 mm across and 1.1 mm width, were cut from a mother sheet formed by a tin float glass process. A 25 mm×35 mm stainless steel mesh screen (0.0078″ wire diameter, 18 square openings per inch) was placed on glass spacers such that the mesh screen was supported at a distance of 0.4 mm above the 25 mm×25 mm surface of the glass sample. The 25 mm×25 mm sample surface was coated with 2.0 g of wet paste of composition 4:1:3 weight ratio of distilled water, C&C clay, and KNO₃ (technical grade). Water was allowed to dry from the paste at room temperature at least 6 hours before the sample was flipped over to coat the second 25 mm×25 mm glass surface with a mesh screen and wet paste using the same procedure as described above. Again, the sample was allowed to dry at room temperature for at least 6 hours. The sample was then placed in a drying oven at over 100° C. for at least 2 hours to remove the remaining water content from the pastes. The quantity of dried paste remaining was sufficient to encapsulate a 25 mm×25 mm area of mesh screen suspended above each of the large glass surfaces, forming an electrode on each of these surfaces. The stainless steel mesh screen was used to distribute the electric potential uniformly over the electrode surface area. After drying, the glass spacers were removed from the edge. Any paste or salt that had migrated to the width (minor) surfaces during drying was removed using cotton swab and isopropanol and dried with a dry cotton swab to ensure that a short-circuit path between the two electrodes did not exist. The electric field-assist chemical strengthening process was accomplished by first bringing the glass with dried paste electrodes to a temperature of 425° C. in a muffle furnace. The dwell time in the furnace after the temperature had been reached was 5 minutes. A variable voltage, regulated DC power supply (brand BK Precision, model 1623A) and a 5½ digit multimeter (brand BK Precision, model 5492B), set to monitor DC current, were electrically connected in series with the two mesh screens.

Electric Field:

An electric potential of 30 volts DC was applied across the electrodes, first driving the potassium ions from the dried paste attached to the positive terminal of the DC potential into the tin side of the glass for 10 minutes (forward half-cycle), then reversing the polarity of the electric potential to drive the potassium ions from the dried paste into the air side of the glass for 7 minutes (backward half-cycle). The procedure of applying the electric potential for a period of time, then reversing the polarity for another period of time established one cycle. This was repeated for a total of four cycles. Finally, the electric potential was applied to drive potassium ions from the dried paste into the tin side of the glass for 2 minutes. The total electric field-assist chemical strengthening time was 70 minutes, after which the DC power supply was disconnected. The sample was then removed from the furnace and was cooled to room temperature. Once at room temperature, the dried paste and mesh electrode combination was removed from the glass by rinsing with water and the sample was dried. This electric field-assist chemical strengthening process was executed for four glass samples. Reference samples were generated by traditional immersion chemical strengthening. Reference A was chemically strengthened at 425° C. for 70 minutes in a beaker of KNO₃ (technical grade) placed within an electrically-heated furnace. Reference B was chemically strengthened at 425° C. for 24 hours in a beaker of KNO₃ (technical grade) placed within an electrically-heated furnace. Chemical strengthening parameters for Reference A were chosen to maximize surface compression and for Reference B were chosen to obtain a case depth comparable to that of the present methodology. During the electric field-assist chemical strengthening process the multimeter was used to monitor the electric current versus time. After the electric field-assist chemical strengthening process, samples were characterized for surface compression and case depth by ellipsometry (brand Orihara, model FSM-6000LE) of each surface.

Results:

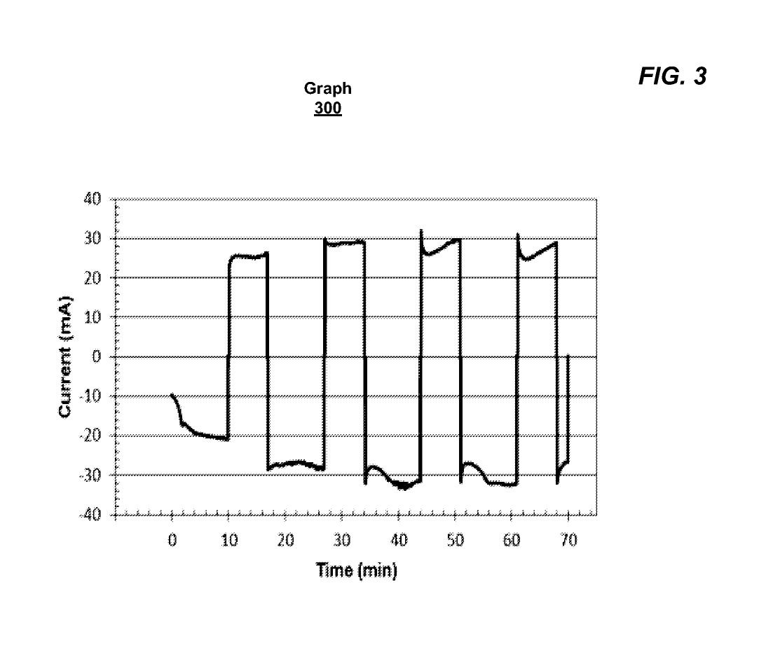

Graph 300 showing electric current in milliamps versus time in minutes for sample S4 is shown in FIG. 3. Polarity reversal changes the sign of the current. Negative current indicates the electric field was driving potassium ions into the tin side surface of the glass sample (forward half-cycle) and positive current indicates the electric field was driving potassium ions into the air side surface of the glass sample (backward half-cycle). Surface compression and case depth are given in Table 1. The average surface compression and case depth for electric field-assist chemically strengthened samples was 814 MPa and 20.2 micron, respectively. For Reference A, the surface compression is approximately 140 MPa lower and case depth is approximately 13 micron lower than the average surface compression and case depth for the electric field-assist chemically strengthened samples. For Reference B, the surface compression is approximately 190 MPa lower but case depth is similar to that of the electric field-assist chemically strengthened samples.

Table 1 below shows the surface compression and case depth of four samples chemically strengthened using the field-assist chemical strengthening process and two traditionally chemically strengthened reference samples.

TABLE 1

| | | |
|---|---|---|
| | Surface | Case |
| Chemical | Compression | Depth |
| Strengthening | (MPa) | (microns) |

| Sample ID | Time (minutes) | Air | Tin | Air | Tin |
|---|---|---|---|---|---|
| S1 | 70 | 810 | 849 | 19.2 | 21.1 |
| S2 | 70 | 866 | 797 | 21.2 | 22.2 |
| S3 | 70 | 876 | 777 | 18.2 | 18.4 |
| S4 | 70 | 787 | 752 | 20.4 | 21.2 |
| Ref. A | 70 | 676 | 607 | 5.1 | 6.6 |
| Ref. B | 1440 | 625 | 606 | 20.2 | 17.4 |

### Example 2

Example 2 demonstrates the preparation of a strengthened soda-lime silicate glass with the electric field-assist chemical strengthening process. Higher surface compression and lower case depth is shown relative to Example 1.

Sample Preparation:

Soda-lime silicate coupons, 25 mm×25 mm across and 0.4 mm width, were cut from a mother sheet formed by a tin float glass process. A 25 mm×35 mm stainless steel mesh screen (0.0078″ wire diameter, 18 square openings per inch) was placed on alumina spacers such that the mesh screen was supported at a distance of 0.63 mm above the 25 mm×25 mm surface of the glass sample. The 25 mm×25 mm sample surface was coated with 1.4 g of wet paste of composition 2:1:3 weight ratio of distilled water, New Zealand clay, and KNO₃ (technical grade). Water was allowed to dry from the paste at room temperature at least 2 hours before the sample was flipped over to coat the second 25 mm×25 mm glass surface with a mesh screen and wet paste using the same procedure as described above. Again, the sample was allowed to dry at room temperature for at least 2 hours. The sample was then placed in a drying oven at 50° C. and the temperature of the oven was increased in 30° C. increments every hour until the temperature was over 100° C. to remove the remaining water content from the pastes. The samples were left in the drying oven at over 100° C. for a minimum time of 2 hours. The quantity of dried paste remaining was sufficient to encapsulate a 25 mm×25 mm area of mesh screen suspended above each of the large glass surfaces, forming an electrode on each of these surfaces. After drying, any paste or salt that had migrated to the edge surfaces during drying was removed using cotton swab and isopropanol and dried with a dry cotton swab. The electric field-assist chemical strengthening process was accomplished by first bringing the glass with dried paste electrodes to a temperature of 400° C. in a muffle furnace. The dwell time in the furnace after the temperature had been reached was 5 minutes. A variable voltage, regulated DC power supply (brand BK Precision, model 1623A) and a 5½ digit multimeter (brand BK Precision, model 5492B), set to monitor DC current, were electrically connected in series with the two mesh screens.

Electric Field:

An electric potential of 15 volts DC was applied across the electrodes, first driving the potassium ions from the dried paste attached to the positive terminal of the DC potential into the tin side of the glass for 8 minutes (forward half-cycle), then reversing the polarity of the electric potential to drive the potassium ions from the dried paste into the air side of the glass for 8 minutes (backward half-cycle). The procedure of applying the electric potential for a period of time, then reversing the polarity for another period of time established one cycle. This was repeated for a total of four cycles. Finally, the electric potential was applied to drive potassium ions from the dried paste into the tin side of the glass for 3 minutes bringing the total cycles to 4½. The total electric field-assist chemical strengthening time was 67 minutes, after which the DC power supply was disconnected. The sample was then removed from the furnace and was cooled to room temperature. Once at room temperature, the dried paste and mesh electrode combination was removed from the glass by rinsing with water and the sample was dried. This electric field-assist chemical strengthening process was executed for three glass samples. Reference samples were generated by traditional immersion chemical strengthening. Reference C was chemically strengthened at 400° C. for 2 hours in a beaker of KNO₃ (technical grade) placed within an electrically-heated furnace. Note, Reference C had dimensional width of 1.1 mm rather than 0.4 mm. Reference D was chemically strengthened at 400° C. for 9 hours in a beaker of KNO₃ (technical grade) placed within an electrically-heated furnace. Chemical strengthening parameters for Reference C were chosen to maximize surface compression and for Reference D were chosen to obtain a similar case depth to the electric field-assist chemical strengthening samples. During electric field-assist chemical strengthening process the multimeter was used to monitor the electric current versus time. After the electric field-assist chemical strengthening process, samples were characterized for surface compression and case depth by ellipsometry (brand Orihara, model FSM-6000LE) of each surface and deflection determination by scanning optical profiler (brand Nanovea, model ST400). Deflection is the peak-to-valley height determined along a line drawn between opposite edge mid-points of the square coupon.

Results:

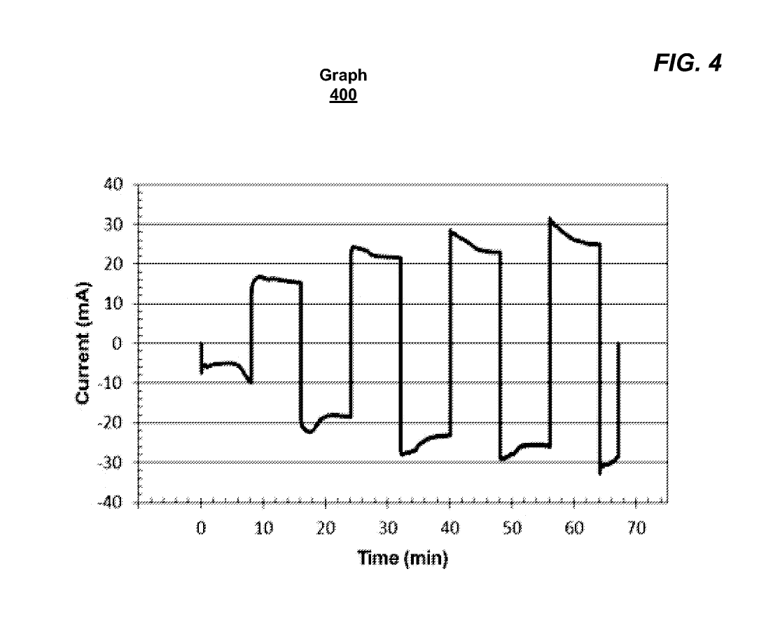

Graph 400 showing electric current in milliamps versus time in minutes for sample S5 is shown in FIG. 4. Polarity reversal changes the sign of the current. Negative current indicates the electric field was driving potassium ions into the tin side surface of the glass sample and positive current indicates the electric field was driving potassium ions into the air side surface of the glass sample. Surface compression, case depth, and deflection are given in Table 2. The average surface compression, case depth, and deflection for electric field-assist chemically strengthened samples were 932 MPa, 8.2 micron, and −18 micron, respectively. For Reference C, the surface compression is approximately 230 MPa lower and case depth is approximately 3.0 micron lower than that of the electric field-assist chemically strengthened samples. For Reference D, the surface compression is approximately 200 MPa lower and case depth is approximately 1.5 micron higher than that of the electric field-assist chemically strengthened samples. The average deflection of the electric field-assist chemically strengthened samples is comparable to that of Reference D in magnitude, but is opposite in direction (air concave rather than air convex) suggesting that the cycle parameters can be optimized to yield essentially flat specimens.

Table 2 below shows surface compression, case depth, and deflection of chemically strengthened samples using the field-assisted ion exchange process and two traditionally chemically strengthened reference samples. Positive deflection indicates air side convex and negative deflection indices air side concave.

TABLE 2

| | | Surface | | | | |
|---|---|---|---|---|---|---|
| | Chemical | Compression | | Case Depth | | |
| | Strengthening Time | (MPa) | | (microns) | | Deflection |
| Sample | (minutes) | Air | Tin | Air | Tin | (microns) |
| S5 | 67 | 873 | 912 | 8.5 | 8.1 | −11 |
| S6 | 67 | 867 | 978 | 8.2 | 7.9 | −18 |
| S7 | 67 | 936 | 1028 | 8.1 | 8.5 | −24 |
| Ref. C | 120 | 701 | 605 | 5.0 | 5.2 | — |
| Ref. D | 540 | 728 | 749 | 9.9 | 7.7 | 14 |

### Example 3

Example 3 demonstrates the preparation of a strengthened soda-lime silicate glass with the electric field-assist chemical strengthening process. To allow for an extended case depth, the samples were initially edge-strengthened and utilized a variable voltage during the electric field-assist chemical strengthening process.

Sample Preparation:

Soda-lime silicate coupons, 25 mm×25 mm across and 0.4 mm width, were cut from a mother sheet formed by a tin float glass process. All four 25 mm×0.4 mm edges were dip coated with wet paste of composition 2:1:3 weight ratio of distilled water, C&C clay, and KNO₃ (technical grade). The paste-coated edges were then allowed to dry at room temperature in front of a fan for at least 20 minutes. After drying the samples were placed into a muffle furnace at 425° C. for one hour. The sample was removed from the furnace and was cooled to room temperature. Once at room temperature, the dried paste was removed from the glass by rinsing with water and the sample was dried. A 25 mm×35 mm stainless steel mesh screen (0.0078″ wire diameter, 18 square openings per inch) was placed on alumina spacers such that the mesh screen was supported at a distance of 0.63 mm above the 25 mm×25 mm surface of the glass sample. The 25 mm×25 mm sample surface was coated with 1.4 g of wet paste of composition 2:1:3 weight ratio of distilled water, C&C clay, and KNO₃ (technical grade). Water was allowed to dry from the paste at room temperature at least 6 hours before the sample was flipped over to coat the second 25 mm×25 mm glass surface with a mesh screen and wet paste using the same procedure as described above. Again, the sample was allowed to dry at room temperature for at least 6 hours. The sample was then placed in a drying oven at over 100° C. for at least 2 hours to remove the remaining water content from the pastes. The quantity of dried paste remaining was sufficient to encapsulate a 25 mm×25 mm area of mesh screen suspended above each of the large glass surfaces, forming an electrode on each of these surfaces. After drying, any paste or salt that had migrated to the width surfaces during drying was removed using cotton swab and isopropanol and dried with a dry cotton swab. The electric field-assist chemical strengthening process was accomplished by first bringing the glass with dried paste electrodes to a temperature of 415° C. in a muffle furnace. The dwell time in the furnace after the temperature had been reached was 5 minutes. A variable voltage, regulated DC power supply (brand BK Precision, model 1623A) and a 5½ digit multimeter (brand BK Precision, model 5492B), set to monitor DC current, were electrically connected in series with the two mesh screens.

Electric Field:

An electric potential of 40 volts DC was applied across the electrodes, first driving the potassium ions from the dried paste attached to the positive terminal of the DC potential into the tin side of the glass for 6.1 minutes (forward half-cycle), then reversing the polarity of the electric potential to drive the potassium ions from the dried paste into the air side of the glass for 6.2 minutes (backward half-cycle). The procedure of applying the electric potential for a period of time, then reversing the polarity for another period of time established one cycle. This was repeated for a total of five cycles. Finally, the electric potential was applied to drive potassium ions from the dried paste into the tin side of the glass for 2 minutes bringing the total number of cycles to 5½. Before each polarity change occurred, the voltage was slowly (5 seconds before the change) reduced to 20 V and after the polarity change the voltage was slowly (15 seconds after the change) increased back to 40 V. The total electric field-assist chemical strengthening time was 64 minutes, after which the DC power supply was disconnected. The sample was removed from the furnace and was cooled to room temperature. Once at room temperature, the dried paste and mesh electrode combination was removed from the glass by rinsing with water and the sample was dried. This electric field-assist chemical strengthening was executed for four glass samples. Reference samples were generated by traditional immersion chemical strengthening. Reference E was chemically strengthened at 415° C. for 24 hours in a beaker of KNO₃ (technical grade) placed within an electrically-heated furnace. Chemical strengthening parameters Reference E were chosen to obtain a case depth comparable to that of the electric field-assist chemical strengthening methodology in this example. During electric field-assist chemical strengthening the multimeter was used to monitor the electric current versus time. After the electric field-assist chemical strengthening process, samples were characterized for surface compression and case depth by ellipsometry (brand Orihara, model FSM-6000LE) of each surface.

Results:

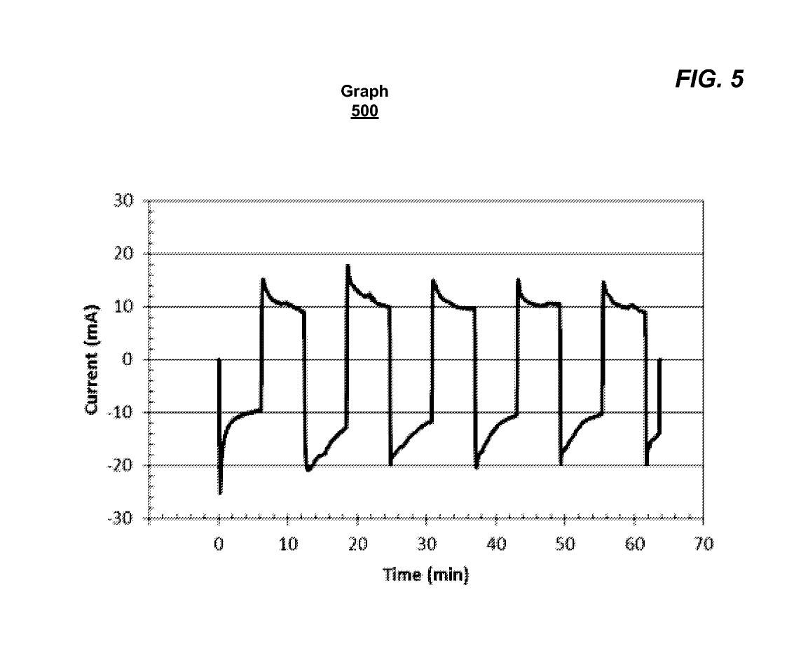

Graph 500 showing electric current in milliamps versus time in minutes for sample S11 is shown in FIG. 5. Polarity reversal changes the sign of the current. Negative current indicates the electric field was driving potassium ions into the tin side surface of the glass sample and positive current indicates the electric field was driving potassium ions into the air side surface of the glass sample. Surface compression and case depth are given in Table 3. The average surface compression and case depth for electric field-assist chemically strengthened samples was 742 MPa and 16.9 micron, respectively. For Reference E, the surface compression is approximately 128 MPa lower while the case depth is similar to that of the electric field-assist chemically strengthened samples.

Table 3 below shows surface compression and case depth of four samples chemically strengthened using the field-assist chemical strengthening process, with edge strengthening and variable voltage, and one traditionally chemically strengthened reference sample.

TABLE 3

| | | |
|---|---|---|
| | Surface | |
| Chemical | Compression | Case Depth |
| Strengthening | (MPa) | (microns) |

| Sample ID | Time (minutes) | Air | Tin | Air | Tin |
|---|---|---|---|---|---|
| S8 | 64 | 752 | 689 | 17.3 | 18.5 |
| S9 | 64 | 785 | 694 | 17.4 | 16.8 |
| S10 | 64 | 766 | 694 | 16.1 | 16.1 |
| S11 | 64 | 862 | 698 | 16.1 | 16.7 |
| Ref. E | 1440 | 619 | 609 | 17.3 | 15.1 |

### Example 4

Example 4 demonstrates the effects of changing the number of cycles within the electric field-assist chemical strengthening process for soda-lime silicate glass.

Sample Preparation:

Soda-lime silicate coupons, 25 mm×25 mm across and 3 mm width, were cut from a mother sheet formed by a tin float glass process. A 25 mm×35 mm stainless steel mesh screen (0.0078″ wire diameter, 18 square openings per inch) was placed on alumina spacers such that the mesh screen was supported at a distance of 0.63 mm above the 25 mm×25 mm surface of the glass sample. The 25 mm×25 mm sample surface was coated with 1.4 g of wet paste of composition 2:1:3 weight ratio of distilled water, New Zealand clay, and KNO₃ (technical grade). Water was allowed to dry from the paste at room temperature at least 2 hours before the sample was flipped over to coat the second 25 mm×25 mm glass surface with a mesh screen and wet paste using the same procedure as described above. Again, the sample was allowed to dry at room temperature for at least 2 hours. The sample was then placed in a drying oven at 50° C. and the temperature of the oven was increased in 30° C. increments every hour until the temperature was over 100° C. to remove the remaining water content from the pastes. The samples were left in the drying oven at over 100° C. for a minimum time of 2 hours. The quantity of dried paste remaining was sufficient to encapsulate a 25 mm×25 mm area of mesh screen suspended above each of the large glass surfaces, forming an electrode on each of these surfaces. After drying, any paste or salt that had migrated to the edge surfaces during drying was removed using cotton swabs and isopropanol and dried with a dry cotton swab. The electric field-assist chemical strengthening process was accomplished by first bringing the glass with dried paste electrodes to a temperature of 400° C. in a muffle furnace. The dwell time in the furnace after the temperature had been reached was 5 minutes. A variable voltage, regulated DC power supply (brand BK Precision, model 1623A) and a 5½ digit multimeter (brand BK Precision, model 5492B), set to monitor DC current, were electrically connected in series with the two mesh screens.

Electric Field:

An electric potential of 45 volts DC was applied across the electrodes, first driving the potassium ions from the dried paste attached to the positive terminal of the DC potential into the tin side of the glass for a set duration (“forward half-cycle time”), then reversing the polarity of the electric potential to drive the potassium ions from the dried paste into the air side of the glass for a set duration (“backward half-cycle time”). The procedure of applying the electric potential for a period of time, then reversing the polarity for another period of time established one cycle. This was repeated for a set number of cycles. Finally, the electric potential was applied one last time to drive potassium ions from the dried paste into the tin side of the glass for a desired duration (“final half-cycle time”). The total electric field-assist chemical strengthening time was 32.5-40 minutes, after which the DC power supply was disconnected. The sample was removed from the furnace and was cooled to room temperature. Once at room temperature, the dried paste and mesh electrode combination was removed from the glass by rinsing with water and the sample was dried. Eight different electric field-assisted chemical strengthening processes were executed using parameters shown below in Table 4. The parameters were selected such that the overall time was about similar. After the electric field-assist chemical strengthening process, samples were characterized for surface compression and case depth by ellipsometry (brand Orihara, model FSM-6000LE) of each surface. Reference samples were generated by traditional immersion chemical strengthening. Reference F was chemically strengthened at 400° C. for 8 hours in a beaker of KNO₃ (technical grade) placed within an electrically-heated furnace.

Table 4 below shows electric field-assist chemical strengthening process parameters selected to demonstrate the effects of changing the number of cycles.

TABLE 4

| | Forward | Backward | | |
|---|---|---|---|---|
| | Half-Cycle | Half-Cycle | | |
| Number | Time | Time | Final Half-Cycle | Total Time |
| of Cycles | (minutes) | (minutes) | Time (minutes) | (minutes) |
| 1 | 16.00 | 16.00 | 8.00 | 40.00 |
| 2 | 8.00 | 8.00 | 4.00 | 36.00 |
| 3 | 5.33 | 5.33 | 2.67 | 34.67 |
| 4 | 4.00 | 4.00 | 2.00 | 34.00 |
| 6 | 2.67 | 2.67 | 1.33 | 33.33 |
| 8 | 2.00 | 2.00 | 1.00 | 33.00 |
| 12 | 1.33 | 1.33 | 0.67 | 32.67 |
| 16 | 1.00 | 1.00 | 0.50 | 32.50 |

Results:

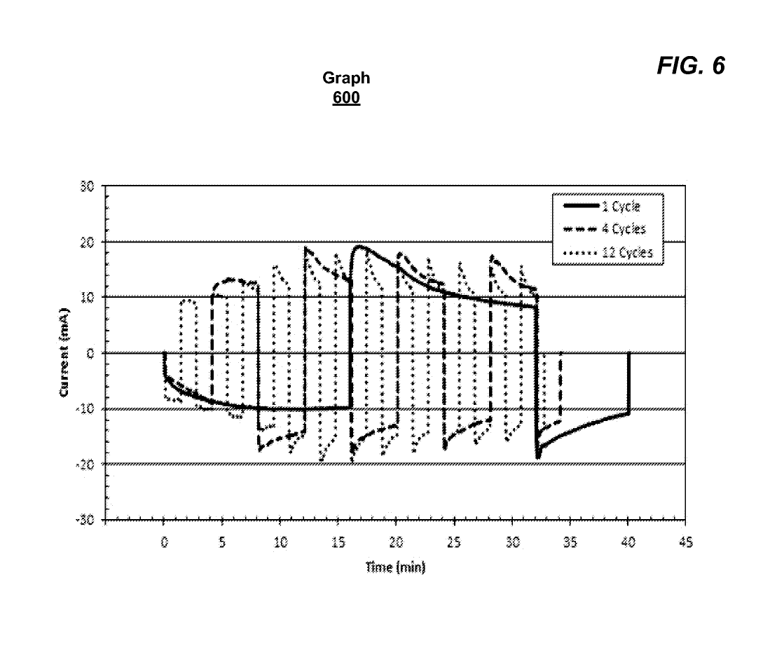

Graph 600 showing electric current in milliamps versus time in minutes for samples with one, four, and 12 cycles is shown in FIG. 6. Polarity reversal changes the sign of the current. Negative current indicates the electric field was driving potassium ions into the tin side surface of the glass sample and positive current indicates the electric field was driving potassium ions into the air side surface of the glass sample. Surface compression and case depth values are given in Table 5 below.

Table 5 shows surface compression and case depth of chemically strengthened samples using the electric field-assisted ion exchange process with varying number of cycles.

TABLE 5

| | | |
|---|---|---|
| | Surface | |
| | Compression | Case Depth |
| Number | (MPa) | (microns) |

| of Cycles | Air | Tin | Air | Tin |
|---|---|---|---|---|
| 1 | 563 | 712 | 14.4 | 16.9 |
| 2 | 661 | 594 | 10.3 | 13.4 |
| 3 | 753 | 884 | 11.1 | 8.6 |
| 4 | 703 | 852 | 10.9 | 10.1 |
| 6 | 709 | 764 | 7.2 | 8.6 |
| 8 | 686 | 841 | 8.5 | 9.1 |
| 12 | 885 | — | 5.6 | — |
| 16 | — | 1012 | — | 7.3 |
| Ref. F | 657 | 771 | 11.8 | 10.2 |

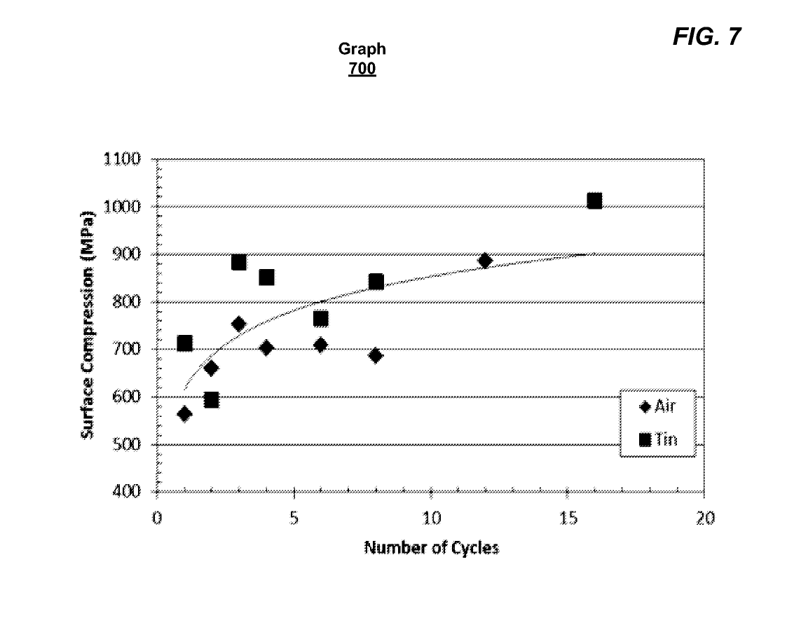

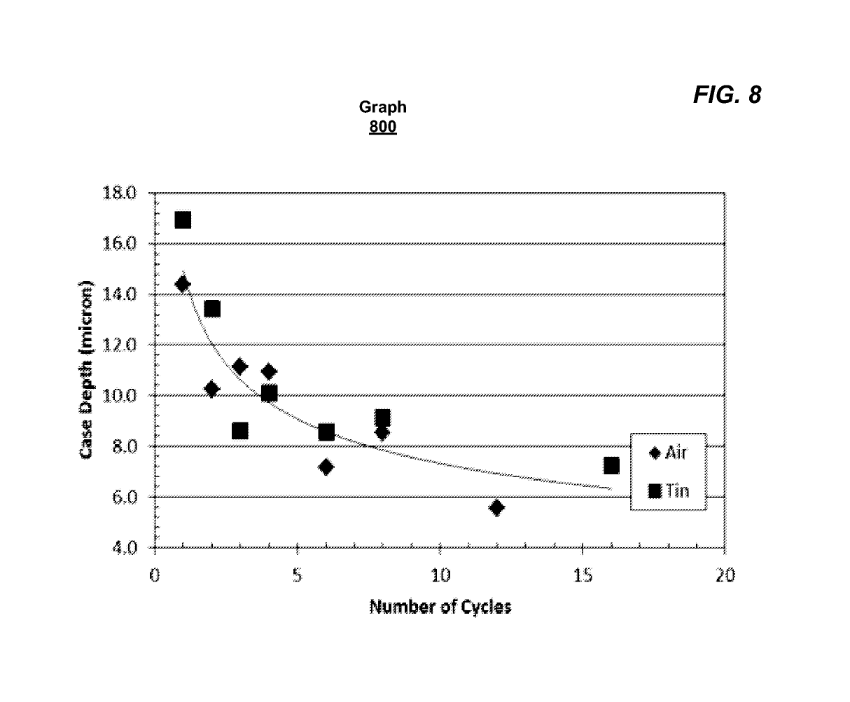

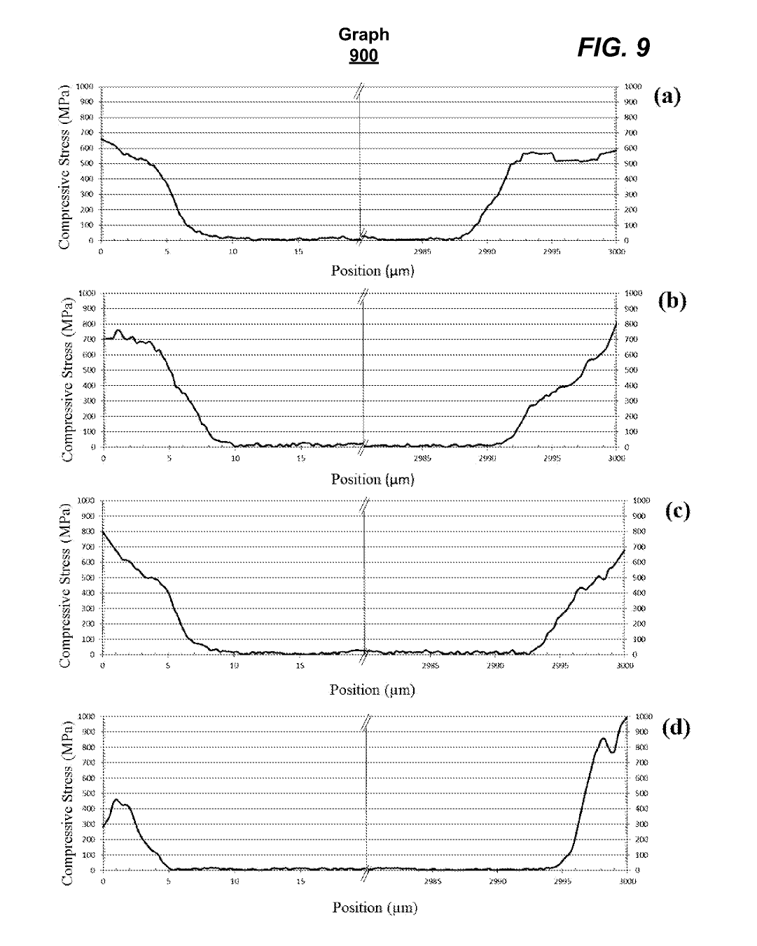

Surface compression in MPa versus number of cycles is shown by graph 700 in FIG. 7. Case depth in microns versus number of cycles is shown by graph 800 in FIG. 8. With an increasing number of cycles there is a general increase in surface compression and a decrease in case depth. Stress profiles shown in graph 900 in FIG. 9 were determined by photo-elastic birefringence of sectioned slices and are given for coupons after electric field-assisted chemical strengthening process with graph 900 (a) two cycles, graph 900 (b) four cycles, graph 900 (c) eight cycles, or graph 900 (d) 16 cycles. Opposing surfaces are positioned at zero and 3,000 microns, and the interior tension profile is not shown. The two cycle process produces low compression magnitude and slightly balanced compressive stress profiles. The four and eight cycle processes produce high compression magnitude and substantially balanced compressive stress profiles. The sixteen cycle process generates high compression magnitude on the tin surface, but low compression magnitude, by comparison, on the air surface and the compressive stress profiles are not well balanced. The four cycle and eight cycle processes display relatively high compression magnitude for both surface regions and relatively balanced compressive stress profiles. The integrated bending force from surface to the mid-plane is given in Table 6, which demonstrates a minimal net bending moment is realized for the four cycle process.

Table 6 shows the calculated integrated bending forces from the stress profiles within FIG. 9.

TABLE 6

| Number of | | | Difference |
|---|---|---|---|
| Cycles | Side | Integrated Bending Force (N) | Air − Tin (N) |
| 2 | Air | 4.8 | −3.2 |
| | Tin | 8.0 | |
| 4 | Air | 3.6 | 1.1 |
| | Tin | 2.5 | |
| 8 | Air | 2.9 | 1.3 |
| | Tin | 1.6 | |
| 16 | Air | 0.4 | −2.5 |
| | Tin | 2.9 | |

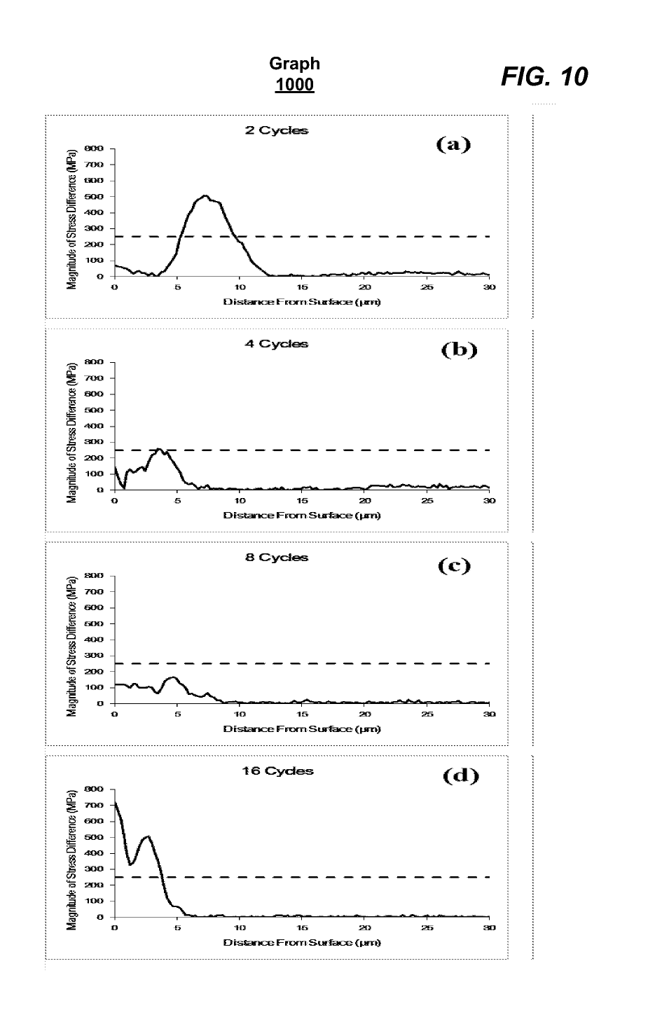

The balancing of the compressive stress profiles shown in graph 900 in FIG. 9 is also demonstrated in graph 1000 of FIG. 10. In this FIG. 10, the magnitude of the stress difference between a first plot of first compressive stress amounts at first depths from the first surface within the first compressive stress layer and a second plot of second compressive stress amounts at second depths from the second surface within the second compressive stress layer is shown. As shown in graph 1000, at a corresponding first depth and second depth from the respective surfaces, a maximum magnitude of the difference between a first compressive stress amount at the first depth and a second compressive stress amount at the second depth, is about 500 MPa or less at 2 cycle (occurring at about 6-7 μm corresponding depths), about 250 MPa or less at 4 cycles (occurring at about 3-4 μm corresponding depths), and is about 180 MPa or less at 8 cycles (occurring at about 4 μm corresponding depths).

### Exemplary Strengthened Glasses

Exemplary embodiments of chemically strengthened glasses made by electric field-assisted chemical strengthening process include soda-lime silicate glass, alkali aluminosilicate glass and sodium borosilicate glass which is strengthened with salts, such as, in potassium nitrate salt baths. Chemical strengthening may be performed at various temperatures, such as at temperatures above about 200° C., preferably about 400° C., and with ion exchange durations of about 0.01 to 4 hours. The zone of compressive stress occurs, for example, within a diffusion depth of about 1, 5, 10, 20, 30, 40, 50, 60, 70, 80, 90, 100, 125 or 150 to about 200 μm of a surface of a substrate glass. According to an exemplary embodiment, compressive stress in a strengthened glass is greatest at a surface (i.e., a “surface compression”) of the glass and the level of compressive stress follows a gradient extending downward from the surface through a case depth in the strengthened glass. In exemplary embodiments, the amount of surface compression may be as low as 500 MPa up to about 1200 MPa or higher in strengthened soda-lime silicate glass and up to about 1200 MPa or higher in aluminosilicate glass. In some exemplary embodiments, surface compression is about 500-1000 MPa in strengthened soda-lime silicate glass and about 600-1100 MPa in aluminosilicate glass. In other exemplary embodiments, surface compression is about 700-900 MPa in strengthened soda-lime silicate glass and about 800-1000 MPa in aluminosilicate glass.

In some exemplary embodiments, a strengthened substrate has a balanced compressive stress profile based on a first plot of first compressive stress amounts at first depths from the first surface within the first compressive stress layer, a second plot of second compressive stress amounts at second depths from the second surface within the second compressive stress layer, and at a corresponding first depth and second depth from the respective surfaces, a magnitude of a difference between a first compressive stress amount at the first depth and a second compressive stress amount at the second depth, is less than 500 MPa. In a preferred embodiment, the magnitude of the difference may vary from 450, 400, 375, 350, 325, 300, 275, 250, 225, 200, 175, 150, 125, 100, 75, 50, 25, 10 to 5 MPa.

The surface compression achieved by electric field-assisted chemical strengthening may vary depending on the type of glass and the case depth achieved through interdiffusion. If the glass is sodium borosilicate having ≧4 mol % and <8 mol % Na₂O below the case depth, the surface compression may be one of >320, 360 or 400 MPa having a case depth≧20 μm, >350, 390 or 430 MPa having a case depth<20 μm and ≧15 μm, >380, 420 or 460 MPa having a case depth<15 μm and ≧10 μm, and >430, 470 or 510 MPa having a case depth less than 10 μm. If the glass is sodium borosilicate having ≧8 mol % and <12 mol % Na₂O below the case depth, the surface compression may be one of >520, 600 or 660 MPa having a case depth≧20 μm, >570, 650 or 730 MPa having a case depth<20 μm and ≧15 μm, >620, 700 or 780 MPa having a case depth<15 μm and ≧10 μm, or >700, 780 or 860 MPa having a case depth less than 10 μm. If the glass is soda-lime silicate, the surface compression may be one of >620, 700 or 780 MPa having a case depth≧20 μm, >670, 750 or 830 MPa having a case depth<20 μm and ≧15 μm, >720, 800 or 880 MPa having a case depth<15 μm and ≧10 μm, or >820, 900 or 980 MPa having a case depth<10 μm. If the glass is alkali aluminosilicate, the surface compression may be one of >800, 900 or 1000 MPa having a case depth≧30 μm, >850, 950 or 1,050 MPa having a case depth<30 μm and ≧20 μm, or >900, 1000 or 1,100 MPa having a case depth<20 μm.

In some exemplary embodiments, commercial soda-lime silicate glass, with potassium replacing sodium, the host glass containing approximately 12-14 mol % Na₂O, having a case depth of less than 10 μm, the surface compression is greater than or equal to 900 MPa; for the glass having a case depth of 10-15 μm, the surface compression is greater than or equal to 800 MPa; for the glass having a case depth of 15-20 μm, the surface compression is greater than or equal to 750 MPa; and for soda-lime silicate glass having a case depth of greater than 20 μm, the surface compression is greater than or equal to 700 MPa. When significantly greater case depths are achieved in soda-lime silicate glass the surface compression is greater than or equal to 675, 650, 625 and 600 MPa.

In some exemplary embodiments, commercial alkali aluminosilicate glass, with potassium replacing sodium, the host glass containing approximately 12-14 mol % Na₂O, having a case depth of less than 20 μm, the surface compression is greater than or equal to 1000 MPa; for the glass having a case depth of 20-30 μm, the surface compression is greater than or equal to 950 MPa; for glass having a case depth of greater than 30 μm, the surface compression is greater than or equal to 900 MPa. When significantly greater case depths are achieved in the alkali aluminosilicate silicate glass the surface compression is greater than or equal to 850, 800, 750, 700 and 600 MPa.

In some exemplary embodiments, commercial sodium borosilicate glass, with potassium replacing sodium, the host glass containing approximately 6 mol % Na₂O, having a case depth of less than 10 μm, the surface compression is greater than or equal to 470 MPa; for the glass having a case depth of 10-15 μm, the surface compression is greater than or equal to 420 MPa; for glass having a case depth of 15-20 μm, the surface compression is greater than or equal to 390 MPa; and for the glass having a case depth of greater than 20 μm, the surface compression is greater than or equal to 360 MPa. When significantly greater case depths are achieved in the sodium borosilicate glass, the surface compression is greater than or equal to 340, 320 and 300 MPa. In other exemplary embodiments in which the host glass may include 2 to 20 mol % Na₂O, wherein, if the glass is sodium borosilicate, the surface compression is one of >60 MPa/mol % Na₂O exchanged and having a case depth≧20 μm, >65 MPa/mol % Na₂O exchanged and having a case depth<20 μm and ≧15 μm, >70 MPa/mol % Na₂O exchanged and having a case depth<15 μm and ≧10 μm, or >75 MPa/mol % Na₂O exchanged and having a case depth less than 10 μm.

In some exemplary embodiments, a strengthened silicate glass, such as soda-lime silicate glass or sodium aluminosilicate glass comprises alumina, at least one alkali metal and, in some embodiments, greater than 50 mol % SiO₂, in other embodiments at least 58 mol % SiO₂, and in still other embodiments at least 60 mol % SiO₂. In these embodiments, a Li₂O+Na₂O+K₂O total mol %, such as in a volume associated with a diffusion depth, is at least about 1, 2, 5, 7 or 8-10 mol % and ≦25 mol %, preferably ≦20 mol %, and more preferably ≦about 2, 5, 7, 8, 10, 12, or 16-18 mol %.

In another exemplary embodiment, an alkali aluminosilicate glass may comprise, consists essentially of, or consist of: 60-75 mol % SiO₂; 5-15 mol % Al₂O₃; 0-12 mol % B₂O₃; 8-21 mol % Na₂O; 0-8 mol % K₂O; 0-15 mol % MgO; and 0-3 mol % CaO. In these embodiments, such as in a volume associated with a diffusion depth, a Li₂O+Na₂O+K₂O total mol % is at least about 1, 2, 5, 7 or 8-10 mol % and ≦25 mol %, preferably ≦20 mol %, and more preferably ≦about 2, 5, 7, 8, 10, 12, 15 or 16-18 mol %.

In yet another embodiment, an alkali aluminosilicate glass substrate may comprise, consists essentially of, or consist of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-15 mol % MgO; 0-10 mol % CaO; 0-5 mol % ZrO₂; 0-2 mol % SnO₂; 0-1 mol % CeO₂; wherein about 1, 2, 5, 7, 8, or 10-12 mol % s Li₂O+Na₂O+K₂O≦about 2, 5, 7, 8, 10, 12, 15 or 16-20 mol %, such as in a volume associated with a diffusion depth, and 0 mol %≦MgO+CaO≦15 mol %.

In another exemplary embodiment, an sodium borosilicate glass may comprise, consists essentially of, or consist of: 60-85 mol % SiO₂; 0-10 mol % Al₂O₃; 5-20 mol % B₂O₃; 3-21 mol % Na₂O; 0-10 mol % K₂O; 0-10 mol % MgO; and 0-10 mol % CaO. In these embodiments, such as in a volume associated with a diffusion depth, a Li₂O+Na₂O+K₂O total mol % is at least about 1, 2, 5, 7 or 8-10 mol % and ≦25 mol %, preferably ≦20 mol %, and more preferably ≦about 2, 5, 7, 8, 10, 12, 15 or 16-18 mol %.

In one example embodiment, sodium ions in the substrate glass are replaced by potassium ions from a molten bath, though other alkali metal ions having a larger atomic radius, such as rubidium or cesium, may replace smaller alkali metal ions in the glass. Similarly, other alkali metal salts such as, but not limited to, nitrates, sulfates, halides, and the like may be used in the ion exchange process.

In another example embodiment, a chemically strengthened glass substrate can have a surface compressive stress of about 200 MPa or more, e.g., about 300, 400, 500, 600, 700, 800, 900, 1000 or 1500 MPa or more, a case depth of about 1 μm or more (e.g., about 1, 5, 10, 20, 25, 30, 35, 40, 45, 50, 55, 60, 65, 70, 75, 80, 85, 90, 95, 100 μm or more) and a diffusion depth of about 1 μm or more (e.g., about 1, 5, 10, 20, 25, 30, 35, 40, 45, 50, 55, 60, 65, 70, 75, 80, 85, 90, 95, 100, 125 or 150 μm or more).

In another example embodiment, a chemically strengthened glass substrate can have a higher amount of metal in at least one surface volume or layer, such as a treatment-rich volume or a treatment-poor volume, than in a bulk volume adjacent these surface volumes. A concentration of metal in at least one of the treatment-poor volume and the treatment-rich volume may be ≦about 0.4, 1.0, 1.5, 2.0, 2.5, 3.0, 4.0, 5.0, 6.0, 8.0, 10.0, 12.0, 15.0, 20 or 25 mol % higher than a concentration of the metal in the bulk volume. According to an embodiment, a concentration of metal in the treatment-poor volume is higher than a concentration of the metal in a treatment-rich volume. An example of strengthened glass with variant metal concentrations in the different volumes is chemically strengthened glass made from a flat glass substrate prepared using a float glass process utilizing tin.

In another example embodiment, a chemically strengthened glass substrate may have an average concentration of alkali ions (e.g. invading alkali ions and host alkali ions) that is the same or different in a diffusion depth of a surface volume than in an adjacent volume, such as a bulk volume. The surface volume may be a treatment rich volume or a treatment-poor volume in the strengthened glass. The average concentration of alkali ions may be the same or different from an average concentration of alkali ions in the adjacent volume, such as a bulk volume. In one example embodiment, the average concentration of alkali ions in the diffusion depth of the surface volume is ≦to about 0.5 mol % higher than a concentration of the alkali ions in the bulk volume. In other embodiments, the average concentration of alkali ions in the diffusion depth of the surface volume is ≦to about 0.4, 0.3, 0.2, 0.1 or 0.05 mol % higher, equal to or less than a concentration of the alkali ions in the bulk volume adjacent the surface volume.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

What is claimed is:

1. A method for making comprising:
providing a substrate having a first surface and a second surface,
wherein the substrate is characterized by having a glass chemical structure including host alkali ions situated in the structure and having an average ionic radius;
providing an exchange medium including invading alkali ions having an average ionic radius that is larger than an average ionic radius of the host alkali ions;
exposing the substrate to the exchange medium; and
conducting ion exchange to produce a strengthened substrate while exposing the substrate to the exchange medium and applying an electric field across the surfaces of the substrate,
wherein applying the electric field includes reversing a polarity of the electric field through a plurality of cycles,
wherein the strengthened substrate has a first compressive stress layer extending from the first surface into the substrate and second compressive stress layer extending from the second surface into the substrate,
wherein the strengthened substrate has a balanced compressive stress profile based on
a first plot of first compressive stress amounts at first depths from the first surface within the first compressive stress layer,
a second plot of second compressive stress amounts at second depths from the second surface within the second compressive stress layer, and
at a corresponding first depth and second depth from the respective surfaces, a magnitude of a difference between a first compressive stress amount at the first depth and a second compressive stress amount at the second depth, is less than 500 MPa.

2. The method of claim 1,
wherein the strengthened substrate has a balanced compressive stress profile based on, at the corresponding first depth and second depth, the difference is less than 250 MPa,
wherein, if the glass is sodium borosilicate having ≧4 mol % and <8 mol % Na₂O below the case depth, the surface compression is one of
>360 MPa having a case depth≧20 μm,
>390 MPa having a case depth<20 μm and ≧15 μm,
>420 MPa having a case depth<15 μm and ≧10 μm,
>470 MPa having a case depth less than 10 μm,
wherein, if the glass is sodium borosilicate having ≧8 mol % and <12 mol % Na₂O below the case depth, the surface compression is one of
>600 MPa having a case depth≧20 μm,
>650 MPa having a case depth<20 μm and ≧15 μm,
>700 MPa having a case depth<15 μm and ≧10 μm,
>780 MPa having a case depth less than 10 μm,
wherein, if the glass is soda-lime silicate, the surface compression is one of
>700 MPa having a case depth≧20 μm,
>750 MPa having a case depth<20 μm and ≧15 μm,
>800 MPa having a case depth<15 μm and ≧10 μm,
>900 MPa having a case depth<10 μm,
wherein, if the glass is alkali aluminosilicate, the surface compression is one of
>900 MPa having a case depth≧30 μm,
>950 MPa having a case depth<30 μm and ≧20 μm,
>1000 MPa having a case depth<20 μm.

3. The method of claim 1, wherein, in applying the electric field, the plurality of cycles includes less than 16 cycles.

4. The method of claim 1, wherein, in applying the electric field, the electric field has a voltage of less than 2,000 volts/mm.

5. The method of claim 1, wherein, in applying the electric field, the electric field has a current of less than 0.0155 amps/mm².

6. The method of claim 1, wherein the conducting of the ion exchange occurs over a period of less than 4 hours.

7. The method of claim 1, wherein edge strengthening is utilized as part of a preparation of the substrate for chemical strengthening.

8. The method of claim 1,
wherein, in conducting the ion exchange, the substrate is held at temperature between 10° C. and 1,400° C.,
wherein the exchange medium is one of a liquid, a solid, a gas or a combination thereof,
wherein the method is one of a continuous process or a batch process.

9. The method of claim 1,
wherein the strengthened substrate is flat and has a width of less than 6.0 mm,
wherein the substrate includes a treatment-rich volume proximate to the first surface and a treatment-poor volume proximate to the second surface, the two volumes located opposed to each other in the substrate.

10. The method of claim 1, wherein the strengthened substrate is curved and has a maximum width of less than 50 mm.

11. The method of claim 1,
wherein the strengthened substrate has a compressive stress layer having a depth of 2-200 μm,
wherein the strengthened substrate consists essentially of one of alkali aluminosilicate glass, sodium borosilicate glass, soda-lime silicate glass.

12. An article of manufacture comprising:
a strengthened substrate having a first surface and a second surface,
wherein the strengthened substrate is characterized by having a glass chemical structure including host alkali ions and invading alkali ions situated in the structure and an average ionic radius of the invading alkali ions is greater than an average ionic radius of the host alkali ions,
wherein the strengthened substrate has a first compressive stress layer extending from the first surface into the substrate and second compressive stress layer extending from the second surface into the substrate,
wherein the strengthened substrate has a first compressive stress layer extending from the first surface into the substrate and second compressive stress layer extending from the second surface into the substrate,
wherein the strengthened substrate has a balanced compressive stress profile based on
a first plot of first compressive stress amounts at first depths from the first surface within the first compressive stress layer,
a second plot of second compressive stress amounts at second depths from the second surface within the second compressive stress layer, and
at a corresponding first depth and second depth from the respective surfaces, a magnitude of a difference between a first compressive stress amount at the first depth and a second compressive stress amount at the second depth, is less than 500 MPa,
wherein, if the glass is sodium borosilicate having ≧4 mol % and <8 mol % Na₂O below the case depth, the surface compression is one of
>360 MPa having a case depth≧20 μm,
>390 MPa having a case depth<20 μm and ≧15 μm,
>420 MPa having a case depth<15 μm and ≧10 μm,
>470 MPa having a case depth less than 10 μm,
wherein, if the glass is sodium borosilicate having ≧8 mol % and <12 mol % Na₂O below the case depth, the surface compression is one of
>600 MPa having a case depth≧20 μm,
>650 MPa having a case depth<20 μm and ≧15 μm,
>700 MPa having a case depth<15 μm and ≧10 μm,
>780 MPa having a case depth less than 10 μm,
wherein, if the glass is soda-lime silicate, the surface compression is one of
>700 MPa having a case depth≧20 μm,
>750 MPa having a case depth<20 μm and ≧15 μm,
>800 MPa having a case depth<15 μm and ≧10 μm,
>900 MPa having a case depth<10 μm,
wherein, if the glass is alkali aluminosilicate, the surface compression is one of
>900 MPa having a case depth≧30 μm,
>950 MPa having a case depth<30 μm and ≧20 μm,
>1000 MPa having a case depth<20 μm.

13. The article of claim 12,
wherein the strengthened substrate has a balanced compressive stress profile based on, at the corresponding first depth and second depth, the difference is less than 250 MPa.

14. The article of claim 12,
wherein the strengthened substrate is flat and has a width of less than 6.0 mm,
wherein the substrate includes a treatment-rich volume proximate to the first surface and a treatment-poor volume proximate to the second surface, the two volumes located opposed to each other in the substrate.

15. The article of claim 12, wherein the strengthened substrate is curved and has a maximum width of less than 50 mm.

16. The article of claim 12,
wherein the strengthened substrate has a compressive stress layer having a depth of 2-200 μm,
wherein the strengthened substrate comprises greater than 50 mole % SiO₂.

17. The article of claim 12,
wherein the strengthened substrate comprises 1 to 25 total mole % of Li₂O+Na₂O+K₂O in a diffusion depth, wherein the diffusion depth is about 5 to 200 μm,
wherein the strengthened substrate has a net bending moment about a mid-plane of about zero.

18. An article of manufacture comprising:
a strengthened substrate having a first surface and a second surface,
wherein the strengthened substrate is characterized by having a glass chemical structure including host alkali ions and invading alkali ions situated in the structure and an average ionic radius of the invading alkali ions is greater than an average ionic radius of the host alkali ions,
wherein the strengthened substrate has a first compressive stress layer extending from the first surface into the substrate and second compressive stress layer extending from the second surface into the substrate,
wherein the strengthened substrate has a balanced compressive stress profile based on
a first plot of first compressive stress amounts at first depths from the first surface within the first compressive stress layer,
a second plot of second compressive stress amounts at second depths from the second surface within the second compressive stress layer, and
at a corresponding first depth and second depth from the respective surfaces, a magnitude of a difference between a first compressive stress amount at the first depth and a second compressive stress amount at the second depth, is less than 500 MPa,
wherein the strengthened substrate is made by a process comprising conducting ion exchange to produce the strengthened substrate while exposing a substrate to an exchange medium and applying an electric field across the surfaces of the substrate.

19. The article of claim 18,
wherein the strengthened substrate has a surface compression that is one of
>300 MPa if a sodium borosilicate glass,
>600 MPa if a soda-lime silicate glass,
>750 MPa if an alkali aluminosilicate glass.

20. The article of claim 19,
wherein the strengthened substrate has a balanced compressive stress profile based on, at the corresponding first depth and second depth, the difference is less than 250 MPa,
wherein, if the glass is sodium borosilicate having ≧4 mol % and <8 mol % Na₂O below the case depth, the surface compression is one of
>360 MPa having a case depth≧20 μm,
>390 MPa having a case depth<20 μm and ≧15 μm,
>420 MPa having a case depth<15 μm and ≧10 μm,
>470 MPa having a case depth less than 10 μm,
wherein, if the glass is sodium borosilicate having ≧8 mol % and <12 mol % Na₂O below the case depth, the surface compression is one of
>600 MPa having a case depth≧20 μm,
>650 MPa having a case depth<20 μm and ≧15 μm,
>700 MPa having a case depth<15 μm and ≧10 μm,
>780 MPa having a case depth less than 10 μm,
wherein, if the glass is soda-lime silicate, the surface compression is one of
>700 MPa having a case depth≧20 μm,
>750 MPa having a case depth<20 μm and ≧15 μm,
>800 MPa having a case depth<15 μm and ≧10 μm,
>900 MPa having a case depth<10 μm,
wherein, if the glass is alkali aluminosilicate, the surface compression is one of
>900 MPa having a case depth≧30 μm,
>950 MPa having a case depth<30 μm and ≧20 μm,
>1000 MPa having a case depth<20 μm.
